(19) United States
(12) Patent Application Publication
(10) Pub. No.: US 2016/0065003 A1
(43) Pub. Date: Mar. 3, 2016

(54) POWER SYSTEM AND METHOD

(71) Applicant: Innovus Power, Inc., Freemont, CA (US)

(72) Inventor: Mark A. PRESTON, Freemont, CA (US)

(73) Assignee: Innovus Power, Inc., Freemont, CA (US)

(21) Appl. No.: 14/836,438

(22) Filed: Aug. 26, 2015

Related U.S. Application Data
(60) Provisional application No. 62/041,895, filed on Aug. 26, 2014.

(51) Int. Cl. H02J 9/06; H02M 3/04; H02M 7/04

(52) U.S. Cl. CPC H02J 9/066; H02M 7/04; H02M 3/04

(57) ABSTRACT

A power system including a variable speed generator set for supplying power to an electrical power grid is provided. The generator set includes an engine and a generator. A power converter is connected to the generator set and a DC bus. The power converter is configured to convert the electrical power provided by the generator set and supply the converted power to the bus. The system includes an energy storage device and a DC to DC converter connected to the energy storage device and the DC bus. A controller is configured to control the amount of power supplied by the energy storage device to the power grid.

### CROSS REFERENCE TO RELATED APPLICATIONS

This application claims priority to and the benefit of U.S. Provisional Patent Application No. 62/041,895, filed on Aug. 26, 2014. The foregoing provisional application is incorporated by reference herein in its entirety.

### SUMMARY

A system for providing power to a motor or other electrical loads using a variable speed power generator is disclosed herein. The variable speed power generator may include a variable speed engine (e.g., an internal combustion engine) and an electrical generator. The engine and generator may be combined as a variable speed genset (VSG). A VSG can run at relatively low loads with much better efficiency and emissions, and lower maintenance costs, than a fixed speed genset (FSG).

According to an embodiment disclosed herein, a power system is provided. The system includes an engine that provides power for driving a generator. The generator is configured to operate at a variable speed and to provide power. A power converter is provided to convert the electrical power provided by the generator into a different form and to supply the converted power to an electrical power grid via a DC bus. An energy storage device can also supply power to the grid.

The power converter may be a rectifier configured to convert AC power to DC power. The system may also include a DC to DC converter connected to the electrical storage device and DC Bus. The system includes a controller that is configured to control the converters, the engine and the generator. The system may also include a DC-AC converter to convert the DC power to supply the AC grid.

The energy storage device may include a capacitor and/or a battery. The capacitor may be an ultra capacitor. In addition, the system may include an energy storage device connected directly to the DC Bus. The energy storage device may be either a capacitor or a battery.

According to another embodiment, a method of providing power to an electrical load connected to a power grid is disclosed. The power grid is configured to receive power from a variable speed generator that is driven by an engine and from an electrical storage device. The method includes adjusting the speed of the engine, while maintaining the voltage of the DC power output within a predetermined range. The method also includes controlling the power supplied by the electrical storage device when power demanded by the load exceeds the power available to be supplied by the variable speed generator. The speed of the engine may be adjusted based on the power demanded by the load.

A DC to DC converter may be connected between the DC bus and the electrical storage device and the method includes controlling the converter to control the amount of power supplied by the electrical storage device. The method may also include controlling the DC to DC converter to limit the charge and discharge rate of the battery. The electrical storage device may include a capacitor connected directly to the DC bus and wherein the method further comprises the step of supplying power from the capacitor during a high speed transient during which the speed of the engine cannot be adjusted fast enough to allow the generator to provide the demanded power.

### BRIEF DESCRIPTION OF THE DRAWINGS

Features, aspects, and advantages of the system and methods disclosed in this application will become apparent from the following description, appended claims, and the accompanying exemplary embodiments shown in the drawings, which are briefly described below.

FIG. 1 is a schematic drawing showing the components of the power system

FIG. 2 is a graph of power versus time showing transients in power.

### DETAILED DESCRIPTION

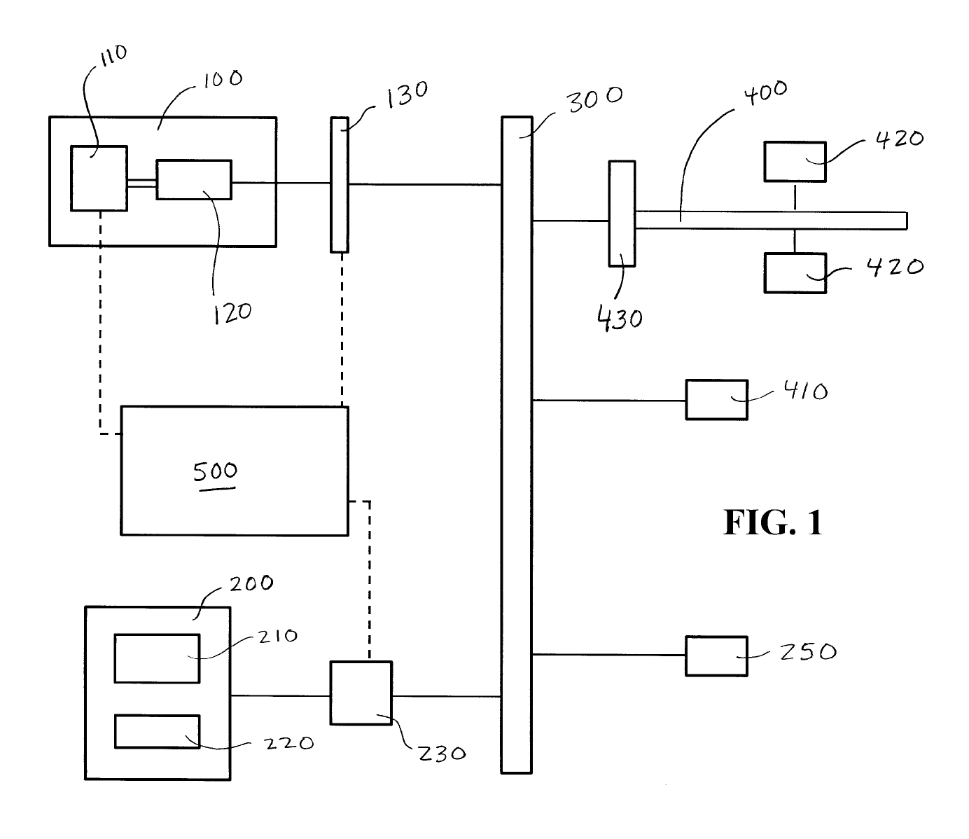

As shown in FIG. 1, the system may include a variable speed generator set 100. The generator set 100 includes an engine 110 and electrical generator 120. The output of the generator 120 may pass through a power converter 130 to supply power to the DC bus 300. The power converter 130 is preferably an active rectifier 130. Various loads may be connected to the DC bus 300. For example, an AC power grid (e.g., microgrid) 400 may be connected to the DC bus 300 via an DC-AC converter 430. One or more AC powered loads 420 may be connected to the grid 400. FIG. 1 shows both AC loads 420 and a DC load 410 connected to the power grid. An inverter 430 may be provided to convert the DC power to AC for the loads 420.

The system may include an energy storage device 200 connected to the DC bus 300. The energy storage device may be capacitive type or battery type storage device connected to the DC bus. The storage device 200 may be connected directly to the DC bus or connected to the DC bus via a DC to DC converter 230 that provides for efficient release or provision of power to or from the storage device. The storage device may be a hybrid storage device including low speed (battery) 210 and high speed (ultracapacitor) 220.

According to one embodiment, the hybrid energy storage system 200 may include two energy sources. One source is a fast or high speed energy storage device such as an ultracapacitor. The other source is a long duration, slow release or steady power device, such as a battery or fuel-cell. A controller 500 is configured to determine when to provide or draw additional power (i.e., current) from the energy storage devices, and when to recharge the energy storage devices.

Either or both of the battery 210 and ultracapacitor 220 may be connected to the DC bus via a DC to DC converter 230. The converter 230 allows the voltage of the ultracapacitor 220 and/or the battery 210 to be different from the DC bus 300. Thus, this arrangement permits the ultra-capacitor and/or the battery to be used over a wide voltage range and a nominal voltage of the ultra-capacitor can be lower. Connecting the battery directly to the DC bus allows the system to be simplified by eliminating the DC-DC converter. The DC bus may be maintained within a range from maximum tolerable voltage for the semiconductor switches to minimum acceptable to, for example, maintain the output of the DC-AC converter at some constant voltage. When the energy storage devices are directly connected to the DC bus, the DC bus voltage may be varied as necessary (within limits) in order to extract the maximum amount of energy from the storage devices. The system may be controlled so that the voltage is maintained within a predetermined range, which may depend on the operation of the inverter or VSD, for example.

The load may be a variable speed motor, because variable speed motor operation is desirable in many applications. Appropriate controls may be provided so that DC-AC converter 430 may operate as either a fixed frequency output or as a variable speed drive (i.e., variable frequency output). By varying motor speed, a variety of benefits may be achieved, including reduced energy consumption, longer component life, elimination of components such as gearboxes and transmissions, etc. The most common and economical types of electric motors, such as synchronous and induction machines, operate at essentially constant speed when connected to a fixed frequency AC supply, such as a conventional power distribution grid or the output of a conventional fixed speed engine-generator set. As a result, it is increasingly common to drive such motors with inverters whose output voltage and frequency can be varied to achieve variable motor speed. These inverters are commonly known as variable speed drives (VSDs), variable frequency drives (VFDs) or adjustable speed drives (ASDs). For example, the inverter 430 shown in FIG. 1, may drive AC loads 420, one or more of which may be a variable speed motor.

In some situations it is desirable to power a single motor with multiple inverters whose outputs are connected in parallel. The use of multiple inverters may be desirable for many different reasons such as, for example: to provide redundant power supplies, to provide sufficient power when the motor's power requirements exceed the output available from a single inverter, or to provide improved overall system efficiency. Examples of parallel power supplies are disclosed in U.S. Pat. Nos. 6,802,679; 7,145,266 and 7,327,111 (all incorporated by reference herein).

In one example, the system provides power to an electric submersible pump (ESP) used in an artificial lift system for oil production. In such a system, a pump with an electric motor is installed at the bottom of an oil well to assist in lifting oil to the surface. In oil production, redundancy is highly desirable for all components because any loss of oil production due to a failed component results in a high economic cost. Although it is not usually economically feasible to install redundant pumps and motors in the well, if the pump motor is driven by e.g. two parallel inverters, each of which can drive the motor at e.g. 80% of the motor's rated power, then a failure in either drive (i.e., inverter) will not cause more than a partial loss of production. As an another alternative, the system may include parallel AC to DC converters (e.g., active rectifiers) in order to provide redundancy at another point in the system.

The power system may be operated by supplying an alternative fuel to the engine. For example, field gas or flare-gas which may be available on site for oil field applications, could be used to supply the engine. In some embodiments, bio-fuel may be used. These types of alternative fuels often provide variability in fuel supply at times providing inconsistent short- and long-term energy content. The use of these alternative fuels in a conventional, fixed-speed diesel electric gensets they can cause variability in the short-term output voltage (e.g., variability in both amplitude and frequency) and power. As a result, both the short- and long-term efficiency and power quality of the genset and the system may be affected. However, the system and method disclosed herein allows for the effective use of alternative fuels. Even for many engines running of more conventional fuels (e.g., natural gas etc.) there are limits in performance during transient conditions even if the fuel quality is constant. As a result, the disclosed system provides improved response by allowing for power to be drawn from an energy storage device during transients. The system also provides for similar response to compensate for variability in the quality or supply of fuel.

As described herein, it is possible to use a variable speed genset with a supplemental energy storage device (or devices) to provide an output voltage and power that does not vary with short-term changes in fuel energy content. It is also possible to adjust the engine speed for a given power output such that maximum efficiency is maintained in both the short- and long-term. The energy storage device is used to release additional power (i.e., stored energy) to make up for any short term (or long term) deficiencies resulting from the engine and generator relying on a potentially variable fuel supply and to compensate for the inherently poor transient response of engines running off of certain fuel supplies such as natural gas or flare gas. The energy storage device is configured to provide only a supplemental source of additional energy (i.e., power). The energy storage device(s) are not configured to provide sufficient power for the load at a peak demand.

In one disclosed embodiment, neither the genset nor the energy storage device(s) are directly connected to the load. The load (e.g., AC power grid) is connected to the DC bus via an inverter and the energy storage device is connected via a DC-DC converter (or directly connected to the DC bus). As explained above, the energy storage device is used to make up the difference between the demand of the load and what the generator can produce.

The energy storage device is used to supplement power during transients resulting from the potentially variable and inconsistent fuel supply and from poor transient response of natural/flare gas engine. The overall efficiency of the system is improved and managed through the use of the variable speed engine. The variable speed genset can provide for substantially constant efficiency with average load over a very wide range. Any difference between the power demand of the load and what the generator is capable of producing at any instant is provided by the energy storage device. The system provides for improved dynamic response resulting from deficiencies and inconsistencies in the fuel supply.

The vast majority of gensets operate at a relatively constant engine speed regardless of the electrical load applied to the genset. This is because most gensets use synchronous machines directly connected to the engine and the grid, which operates at a constant frequency, or to an isolated electrical network (microgrid) that requires constant frequency electricity. If instead, the generator is indirectly connected to the grid through one or more electronic power converters multiple advantages are obtained. The output of the power converters can be connected to the grid (and indirectly to the energy storage device(s)), thereby decoupling the grid from short-term changes in the generator output resulting from engine performance changes resulting from, for example, from inconsistent fuel energy content or poor transient response. The generator and engine can operate at frequencies independent of the grid. This arrangement provides an advantage over fixed gensets, because the engine operating speed can be set to optimize fuel efficiency for different short- and long-term fuel energy content, thereby saving substantial fuel and operating cost. The disclosed system also increases system stability, particularly when there are multiple gensets in parallel and varying load or other sources (e.g. solar with clouds passing over) because the output frequency can remain constant during load changes. Fluctuations in frequency is one of the primary sources of of instability in power grids (e.g., microgrids) supplied by gensets. These fluctuations or instability and typically limits the amount of renewable energy supplies that can be installed or load variation that can be tolerated.

The system is configured to be able to charge the energy storage device whenever the energy storage device is not fully charged and the generator has additional capacity (i.e., the load demand is not at a maximum and the load demand is less than what the generator can produce, based on the instantaneous conditions). The charging of the energy storage device(s) is controlled by either adjusting the DC bus voltage via the active rectifier or by using the DC-DC converter to control charge/discharge current.

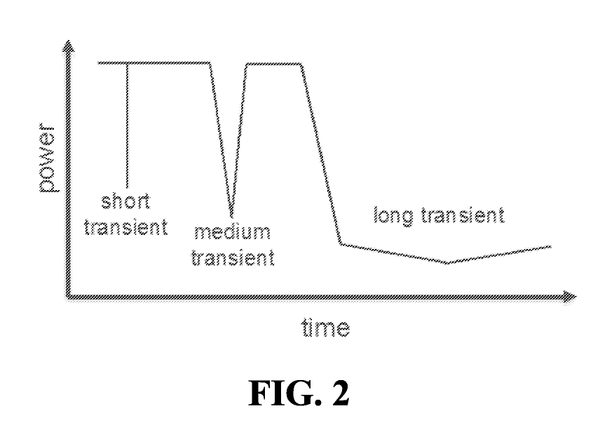

FIG. 1 shows a variable speed genset configured to operate with stored energy devices. During normal operation energy is stored. During short- and medium-term transients (e.g., caused by fuel variability), as shown in FIG. 2, the energy storage device can provide power to make up any difference in power between the power supplied by the genset the power demanded by the load. In the case of very short-term transients, capacitive energy storage directly connected to the DC bus may be sufficient. In the case of medium-term transients a hybrid of low speed (battery) and high speed (ultra capacitor) energy storage connected to the DC bus via a DC-DC power converter may be used to provide the appropriate power based on speed/cost/life considerations. In the case of long term or extended transients, the engine speed can be controlled quickly enough to provide constant output and the need for supplemental power from the energy storage device is not required. The system controller 500 may be configured to control both the output of the generator via the rectifier 130 and, also, the engine speed via the throttle position. For example, the controller 500 may send a speed command to a separate engine controller which adjusts the throttle position.

As shown in FIG. 1, the system may include an energy storage device 200 directly connected to the DC bus 300. The storage device 200 may include only a battery 210 or be configured as a hybrid energy storage device that integrates both a battery 210 and a high speed energy source 220 such as, for example, a super or ultracapacitor. Either or both of the battery and ultracapacitor may be connected to the DC bus 300 via a DC to DC converter 230. The converter 230 allows the voltage of the ultracapacitor and/or the battery to be different from the DC bus 300. Thus, the use of the converter 230 permits the ultra-capacitor and/or the battery to be used over a wide voltage range and a nominal voltage of the ultra-capacitor can be lower. As an alternative, connecting the battery directly to the DC bus allows power to be drawn directly from the battery during transients based on a drop in the DC bus voltage.

As described above, according to one embodiment, the system includes an ultracapacitor and a battery in an integrated device. The ultracapacitor can provide high current for a short duration while the battery (e.g., multiple batteries or battery cells) provides a lower current over a longer period of time. The DC-DC converter is provided to connect the storage device to the DC bus. The DC-DC converter allows the system to function efficiently while the voltage on the DC bus is relatively stable (e.g., only varies 10-20 percent) and, at the same time, the voltage of the storage device may change depending on the amount of energy stored in the ultracapacitor and batteries.

During operation, whenever the load is greater than what the diesel engine can supply (e.g., during periods when the supply of fuel is unreliable or inconsistent), power may be drawn from the hybrid energy storage device (e.g., by raising the voltage on the bus side of the DC-DC converter above the DC bus). Alternatively, for a directly connected energy storage device (e.g., device 250) a decrease in the DC bus voltage causes energy to be drawn from the storage devices. The system controller 500 may include a predetermined lower limit of voltage at which no more energy could be drawn from the storage device. Whenever the load is less than the capacity of the engine, the hybrid energy storage device could be charged with up to that load difference (e.g., by lowering the bus voltage side of the DC-DC converter below the DC bus). Also, the DC bus voltage could be raised in order to add energy to a directly connected energy storage device. The charging could continue until the devices reach capacity (or the DC bus rises to the safe limit of the semiconductor switches in the converter). The system controller 500 may also incorporate a charge management system for the batteries that may be configured to limit charge and discharge rates for the batteries. The charge management system may also be implemented in a separate battery controller. Although shown as a single controller 500 in FIG. 1, the various control functions described herein may be implemented using separate controllers for the various components such as, for example, power converters, rectifiers, inverters, variable speed drives, engine speed controller, etc.

In another embodiment, the system may include a separate capacitor 250 connected directly to the DC bus. This storage capacitor 250 may be the sole energy storage device or used in addition to the integrated ultracapacitor and battery. Also, a separate battery (not shown) may be provided connected directly to the DC bus. The use of the capacitor connected to the DC bus will improve the stability of the system during high speed transients, during which the VSG cannot does not react quickly enough. Also, if a capacitor is connected directly to the DC bus, the DC-DC converter may be eliminated. The amount of energy stored is a function of the voltage difference (i.e., E=0.5 CV²). This embodiment may be used effectively during very short transients. In this embodiment, the capacitor connected directly to the bus would only draw energy as the bus voltage changed and would not require additional controls.

If the energy storage is a capacitor or another device directly connected to the DC bus then the stored energy may be controlled by changing the DC bus voltage using the AC to DC converter 130. The voltage and charge/discharge of the device(s) may be controlled within a predetermined range via the AC-DC converter or allowed to vary naturally as the DC bus voltage increases or decreases depending on the net energy flow. For example, when there is not enough generator power to supply the loads on the system, the DC bus voltage will begin to drop and the energy will flow out of the storage device thereby maintaining the DC bus at a higher voltage for a longer time and, in the case where there is a DC-AC converter (e.g., converter 430), allowing the AC output to remain constant for a longer period. Following such an event, when there is sufficient generator power available, the DC bus voltage may increase to a maximum value via the active rectifier in order to charge the energy storage device(s) and provide maximum stored energy available to supply another energy shortfall. For a storage device connected to the DC bus by a DC-DC converter, charge and discharge of the device may be controlled in a similar manner (i.e., dependent on DC bus voltage) or, the charge and discharge can be actively controlled using the DC-DC converter to boost or buck voltages.

The controller for the engine and genset may be loaded with a default power-speed-efficiency curve based on typical fuel. In the case of short-, medium-, and long-term transients, the control for the genset (i.e., the curve) may be modified based on the amount of alternative fuel required to produce a given power relative to the typical fuel. The speed of the engine is controlled using the modified power-speed-efficiency curve as a guide. This method allows the genset to be controlled at different speeds that allow maximum efficiency to be achieved for a given power as the fuel energy content varies. In the case of very long term changes in fuel energy content, the system essentially operates at steady state and the previously disclosed method for efficiency optimization can be used.

What is claimed is:

1. A power system comprising:
an engine providing power for rotating a generator;
the generator is configured to operate at a variable speed, wherein the generator provides electrical power;
a power converter for converting the form of the electrical power provided by the generator and supplying the converted power to an electrical power grid;
a energy storage device connected to the electrical power grid.

2. The power system of claim 1, wherein the power converter is configured to convert AC power to DC power so that the output of the generator is supplied to a DC bus.

3. The power system of claim 2, further comprising an inverter connected to the DC bus and the electrical power grid.

4. The power system of claim 2, further comprising a DC to DC converter connected to the electrical storage device and the DC bus.

5. The power system of claim 1, wherein the energy storage device comprises capacitive energy storage.

6. The power system of claim 5, wherein the energy storage device comprises a battery.

7. The power system of claim 4, wherein the energy storage device includes an ultra capacitor.

8. The power system of claim 2, further comprising a second energy storage device connected directly to a DC bus.

9. The power system of claim 8, wherein the second energy storage device comprises capacitive energy storage.

10. The power system of claim 4, further comprising a controller configured to control the operation of the DC to DC converter.

11. The power system of claim 1, further comprising a controller configured to control the power provided by the energy storage device to the electrical power grid.

12. The power system of claim 11, wherein further comprising a DC to DC converter connected to the electrical storage device, and wherein the controller is configured to control the operation of the DC to DC converter in order to control the power provided by the energy storage device to the electrical power grid.

13. A method of providing power to an electrical load connected to a power grid, wherein the power grid is configured to receive power from a variable speed generator that is driven by an engine and from an electrical storage device, the method comprising the steps of:
adjusting the speed of the engine, while maintaining the voltage of the power grid within a predetermined range;
controlling the power supplied by the electrical storage device when power demanded by the load exceeds the power available to be supplied by the variable speed generator.

14. The method of claim 13, wherein a DC to DC converter is connected between the power grid and the electrical storage device and the method includes controlling the converter to control the amount of power supplied by the electrical storage device.

15. The method of claim 14, further comprising the step of controlling the DC to DC converter to limit the charge and discharge rate of the battery.

16. The method of claim 13, further comprising the step of adjusting the speed of the engine based on the power demanded by the electrical load; and wherein the electrical storage device includes a capacitor connected directly to the power grid and wherein the method further comprises the step of supplying power from the capacitor during a high speed transient during which the speed of the engine cannot be adjusted fast enough to allow the generator to provide the demanded power.

17. A power system comprising:
a variable speed generator set including an engine and a generator;
a power converter connected to the generator set and a DC bus, wherein the power converter is configured to convert the electrical power provided by the generator set and supply the converted power to the DC bus;
an energy storage device and a DC to DC converter connected to the energy storage device and the DC bus; and
a controller configured to control the amount of power supplied by the energy storage device to the DC bus.

18. The system of claim 16, wherein the controller is configured to control the amount of power drawn by the energy storage device from the DC bus.

19. The system of claim 16, wherein the power converter comprises an active rectifier.

20. The system of claim 16, wherein the energy storage device includes a battery.
